(19) United States
(12) Patent Application Publication
(10) Pub. No.: US 2017/0150865 A1
(43) Pub. Date: Jun. 1, 2017

(54) DUSTING PAD

(71) Applicant: Dan Lennart Blom, Chino, CA (US)

(72) Inventor: Dan Lennart Blom, Chino, CA (US)

(21) Appl. No.: 14/953,950

(22) Filed: Nov. 30, 2015

(51) Int. Cl. A47L 13/16; B25G 1/04; A47L 13/29

(52) U.S. Cl. CPC A47L 13/16; A47L 13/29; B25G 1/04; D04B 39/00

(57) ABSTRACT

A dusting pad. The dusting pad may comprise a base layer, a first material, and a second material, wherein the base layer is constructed of a first synthetic material; wherein the first material comprises a first plurality of threads in stitched relation with a bottom face of the base layer; wherein the first plurality of threads project outwardly from the bottom face of the base layer; wherein the second material comprises a second plurality of threads in stitched relation with the bottom face of the base layer; and wherein the first plurality of threads, on average, has a greater average pile height than the second plurality of threads.

### FIELD OF USE

The present disclosure relates generally to dusting pads, and more particularly, to dusting pads comprising various knitted material, such as microfiber and polyester material.

### BACKGROUND

Various dusting pads have been used to dust surfaces. Dusting pads are generally coupled to a cleaning utensil such as a wand or push stick and usually include traditional dusting material such as feathers or fluffy material. The dusting surface material is generally used to disturb dirt and other micro particles and is preferably located at the bottom face of the dusting pad. The rear face of the dusting pad may include fasteners used for attaching the dusting pad to the wand or push stick, and the advantages of utilizing such dusting pads is to remove dust that has settled on a particular surface.

In recent years, the use of synthetic and natural fibers for dusting pads such as microfiber material has been gaining popularity. Unlike the traditional dusting pads, microfiber tends to attract more dust and common household allergens, resulting in an increase in dusting efficiency. In particular, the microfibers in these pads are usually positively charged, causing dust to be attracted to the pads. Thus, unlike traditional feather or fluffy dusters, which tend to simply displace dust, microfiber tends to attract even the tiniest specks or particles.

There are also various dusting options available which involve multiple material types which are able to trap dust. However, these options tend to not be washable and are often disposable, causing unnecessary waste and harm to the environment.

Therefore, there is a need for a new and improved dusting pad that is more efficient in dusting surfaces than traditional dusting pads. Preferably, the new and improved dusting pad may be efficient in lifting and trapping dust and other small particles.

### SUMMARY OF EMBODIMENTS

To minimize the limitations in the prior art, and to minimize other limitations that will become apparent upon reading and understanding the present disclosure, the present specification discloses a new and improved dusting pad.

One embodiment may be a dusting pad comprising: a base layer; a first material; and a second material; wherein the base layer may be constructed of a first synthetic material; wherein the first material comprises a first plurality of threads in stitched relation with a bottom face of the base layer; wherein the first plurality of threads project outwardly from the bottom face of the base layer; and wherein the second material comprises a second plurality of threads in stitched relation with the bottom face of the base layer; wherein the first plurality of threads have a greater average pile height than the second plurality of threads. The first plurality of threads may comprise a plurality of fully drawn yarns. The plurality of fully drawn yarns of the first material may be 150d/96f fully drawn yarns. Manufacturing of the plurality of fully drawn yarns of the first material may include a steaming process. The steaming process of the plurality of fully drawn yarns of the first material may be performed with dry saturated steam at a temperature in a range between approximately 120 and 160 degrees Celsius for approximately 8 hours. The second plurality of threads may be a second synthetic material. The second synthetic material may be a polyester. The second plurality of threads may comprise a plurality of cationic draw textured yarns. The plurality of cationic draw textured yarns may be 3 ply 150d/288f polyester yarns. The first synthetic material of the base layer may be a 100d/36f drawn textured polyester yarn. A pile height of the first material may be in the range between approximately 18 mm to 20 mm and a pile height of the second material may be in the range between approximately 8 mm to 10 mm. A weight per unit area of the dusting pad may be in the range between approximately 500 to 540 grams per square meter. The top face of the base layer may comprise a hook and loop material; and the dusting pad may be adapted to be removeably attached to a cleaning apparatus.

Another embodiment may be a dusting pad comprising: a base layer; a first material; and a second material; wherein the base layer may be constructed of a first synthetic material; wherein the first material may comprise a first plurality of threads in stitched relation with a bottom face of the base layer; wherein the first plurality of threads may project outwardly from the bottom face of the base layer; wherein the second material may comprise a second plurality of threads in stitched relation with the bottom face of the base layer; wherein the first plurality of threads, on average, may have a greater average pile height than the second plurality of threads; wherein the first plurality of threads may comprise a plurality of fully drawn yarns; wherein the plurality of fully drawn yarns of the first material may be 150d/96f fully drawn yarns; wherein a manufacturing of the plurality of fully drawn yarns of the first material may include a steaming process; wherein the steaming process of the plurality of fully drawn yarns of the first material may be performed with dry saturated steam and at a temperature in a range between approximately 120 and 160 degrees Celsius for approximately 8 hours; wherein the second plurality of threads may be a second synthetic material; wherein the second plurality of threads may comprise a plurality of cationic draw textured yarns; wherein the plurality of cationic draw textured yarns may be 3 ply 150d/288f polyester yarns; wherein the first synthetic material of the base layer may be a 100d/36f drawn textured polyester yarn; wherein a pile height of the first material may be in the range between approximately 18 mm to 20 mm; wherein a pile height of the second material may be in the range between approximately 8 mm to 10 mm; wherein a weight per unit area of the dusting pad may be in the range between approximately 500 to 540 grams per square meter; wherein the top face of the base layer may comprise a hook and loop material; and wherein the dusting pad may be adapted to be removeably attached to a cleaning apparatus.

It is an object to provide a dusting pad that is adapted to be used on various surfaces, including hardwood, marble, and laminate floors.

It is an object to provide a dusting pad that is adapted to perform multiple functions, including dusting surfaces as well as attracting micro particles and dirt.

It is an object to provide a dusting pad that is washable and reusable.

It is an object to overcome the deficiencies of the prior art.

These, as well as other components, steps, features, objects, benefits, and advantages, will now become clear from a review of the following detailed description of illustrative embodiments, of the accompanying drawings, and of the claims.

### BRIEF DESCRIPTION OF THE ILLUSTRATIVE EMBODIMENTS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

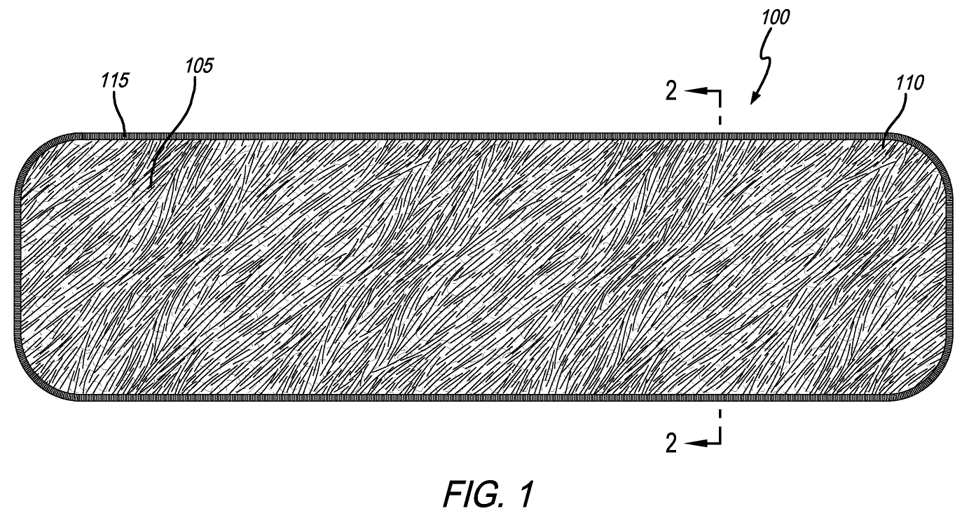

FIG. 1 is an illustration of a bottom face of one embodiment of the dusting pad.

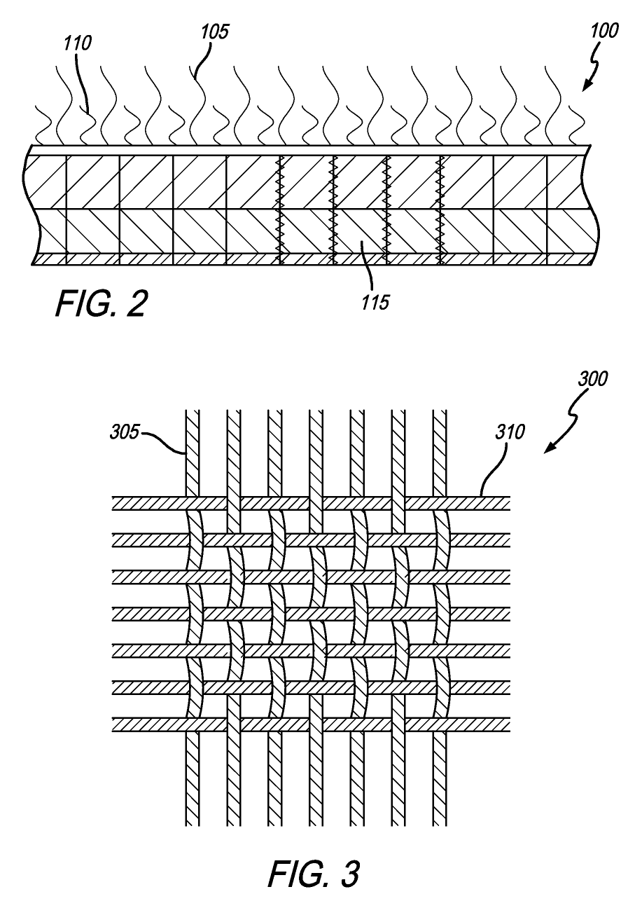

FIG. 2 is an illustration of a cross-section view of one embodiment of the dusting pad.

FIG. 3 is a close up illustration of one embodiment of the base layer.

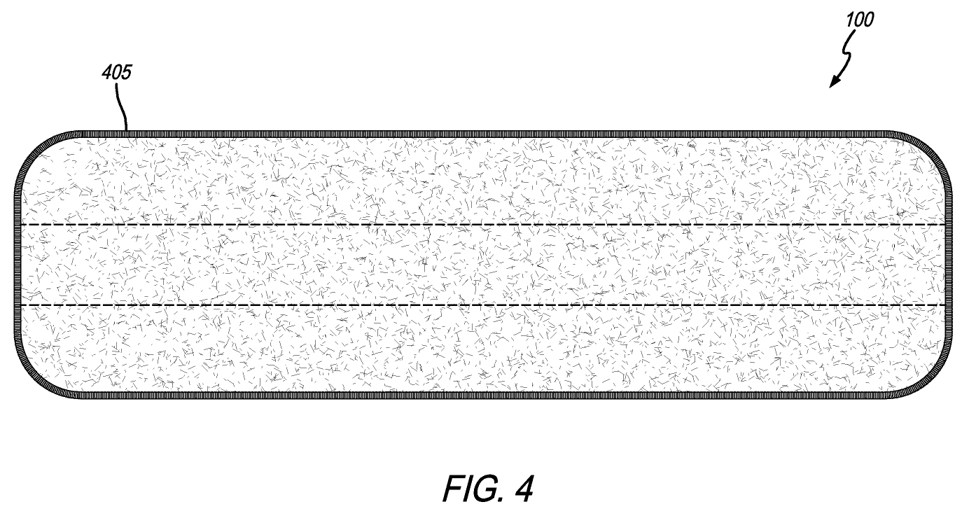

FIG. 4 is an illustration of a top face of one embodiment of the dusting pad.

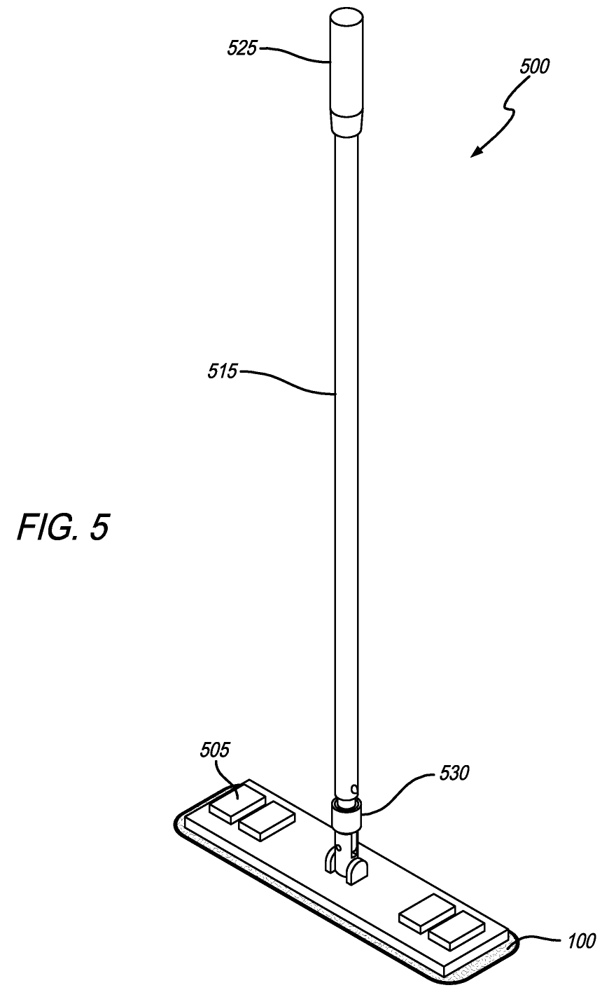

FIG. 5 is an illustration of one embodiment of a dusting pad attached to a cleaning apparatus.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, refer to a deviance of between 1-10% from the indicated number or range of numbers.

As used herein, the term “pile height” refers to the measurement from the surface of the back to the top of a dusting pad's pile, not including the thickness of the back of the pad.

FIG. 1 is an illustration of a bottom face of one embodiment of the dusting pad. As shown in FIG. 1 one embodiment of the dusting pad 100 may comprise: a first material 105, second material 110, and a base layer 115. The first material 105 and second material 110 are preferably stitched material such as fabric, yarn, or polyester, adapted to lift and trap dust from various surfaces. The base layer 115 is generally absorbent material comprising of warp yarns 305 and weft yarns 310 (both shown in FIG. 3) interwoven with each other and used for stitch bonding of the first material 105 and second material 110. Thus, the first material 105 and second material 110 are preferably stitched onto the base layer 115 and may be a single color or multicolored.

The first material 105, second material 110, and base layer 115 are preferably constructed of different yarn materials in order to perform multiple functions such as disturbing settled dust, attracting dust, and holding onto dust. For example, in one embodiment, the first material 105 may be constructed of a yarn; the second material 110 may be constructed of polyester; and the base layer 115 may be constructed of polyester. In another embodiment, the first material 105 may be constructed of a 150d/96f steamed fully drawn yarn; the second material 110 may be constructed of 3 plied 150d/288f cationic drawn textured yarn polyester; and the base layer 115 may be constructed of 100d/36f polyester and/or 150d/96f fully drawn polyester yarns. The first material 105, second material 110, and base layer 115 may comprise synthetic materials.

In a preferred embodiment, the first material 105 may be constructed of a 150d/96f steamed fully drawn yarn, so that the steaming process used may cause the yarn to shrink less during the dyeing process. The steaming process may be performed with dry saturated steam and at a temperature in a range between approximately 120 and 160 degrees Celsius for approximately 8 hours. Still, in this preferred embodiment, the second material 110 may be constructed of 3 plied 150d/288f cationic drawn textured yarn polyester. Additionally, in this preferred embodiment, the base layer 115 may be constructed of 100d/36f drawn textured yarn polyester.

The first material 105 and second material 110 may preferably be constructed of different materials in order to perform different functions in removing and trapping dust. For example, in the above embodiments, the first material 105 may be constructed of a fully drawn yarn in order to lift various dust and micro particles, and the second material 110 may be constructed of a cationic drawn textured yarn polyester fabric to trap dust after the dust is lifted by the first material 105. This may allow this embodiment of the dusting pad 100 to perform dual functions—e.g., lifting and trapping dust particles.

Additionally, the first material 105 may have a greater average pile height than the second material 110, at least when the dusting pad 100 is in use. Preferably, the first material 105 functions to lift dust from surfaces, and the second material 110 functions to trap the dust as it is lifted by the first material 105. In one embodiment, the first material 105 may have a pile height of between 18 millimeters and 20 millimeters, while the second material 110 may have a pile height of between 8 millimeters and 10 millimeters.

In accordance with various embodiments, the dusting pad 100 may have a mass per unit area of about 300 to 700 grams per square meter, more preferably about 400 to about 600 grams per square meter and most preferably about 520 grams per square meter. The dusting pad 100 may also have a pile height of about 5-25 millimeters and more preferably about 8 to about 20 millimeters. Of course, while this embodiment of the dusting pad 100 illustrated in FIG. 1 is only shown using having two types of material, it is contemplated that a greater number of materials may be used if desired.

FIG. 2 is an illustration of a cross-section view of one embodiment of the dusting pad. As shown in FIG. 2 one embodiment of the dusting pad 100 may comprise: a first material 105, second material 110, and a base layer 115. FIG. 2 shows that first material 105 and second material 110 are preferably stitched or otherwise integrated with the base layer 115.

FIG. 2 also shows that the first material 105, second material 110, and base layer 115 are preferably constructed of different yarn materials in order to help lift and trap dust and particles and clean various types of surfaces. As discussed above, in one embodiment, the first material 105 may be constructed of a fully drawn yarn; the second material 110 may be constructed of polyester fabric; and the base layer 115 may be constructed of polyester fabric.

In a preferred embodiment, however, the first material 105 may be constructed of a 150d/96f steamed fully drawn yarn; the second material 110 may be constructed of 3 plied 150d/288f cationic drawn textured yarn polyester; and the base layer 115 may be constructed of 100d/36f drawn textured yarn polyester.

FIG. 2 also shows that the first material 105 and second material 110 are interspersed throughout the base layer 115. As shown in FIG. 2, the first material 105 generally has a pile height that is greater than the pile height of the second material 110, but there may be instances where individual threads of the second material 110 extend further from the base layer 115 than the first material 105. Preferably, the first material 105 and the second material 110 are substantially evenly distributed throughout the base layer 115.

FIG. 3 is a close up illustration of one embodiment of the base layer. As shown in FIG. 3, one embodiment of the base layer 300 may comprise warp yarns 305 and weft yarns 310. The warp yarns 305 may be fabric that is tightly stretched lengthwise, and the weft yarns 310 may be fabric that is woven between the warp yarns 305. In one embodiment, the warp yarns 305 may be stronger and coarser than the weft yarns 310 in order to withstand tight stretching during weaving. The warp yarns 305 may also be coarser to provide core support for the dusting pad.

The warp yarns 305 and weft yarns 310 may collectively make up the base layer, and the warp yarns 305 and/or weft yarns 310 may be one color, or multicolored. In various embodiments, the warp yarns 305 and weft yarns 310 may together create various patterns and forms. Some weavers also may use different types of material for an assortment of textures.

In various embodiments, the base layer may comprise multiple additional layers of warp yarns 305 and/or weft yarns 310. For example, in another embodiment, the base layer may be constructed with an additional layer of warp yarns 305 and weft yarns 310, such that the base layer may be a double layer of warp yarns 305 and weft yarns 310.

In one embodiment, the weft yarns 310 and the warp yarns 305 may be polyester yarns. In a preferred embodiment, the weft yarns 310 and the warp yarns 305 may be 100d/36f drawn textured yarn polyester. In an alternative embodiment, the weft yarns 310 may be draw textured polyester yarns, and the warp yarns 305 may be fully drawn polyester yarns. In an alternative embodiment, the weft yarns may be 300d/96f draw textured polyester yarns, and the warp yarns may be 150d/96f fully drawn polyester yarns.

FIG. 4 is an illustration of a bottom view of one embodiment of the dusting pad. As shown in FIG. 4, one embodiment of the dusting pad 100 may comprise hook and loop fastening material 405. The hook and loop fastening material 405 may be positioned at the top face of the dusting pad 100 and may be adapted to removeably attach the dusting pad 100 to hook and loop fasteners of a cleaning apparatus. Although FIG. 4 shows the hook and loop fastening material 405 may be located throughout almost the entire top face of the dusting pad 100, the hook and loop fastening material 405 may be positioned at one or multiple regions of the top face of the dusting pad 100.

FIG. 5 is an illustration of one embodiment of a dusting pad attached to a cleaning apparatus. As shown in FIG. 5, one embodiment of the cleaning apparatus 500 may comprise an attachment head 505 and an elongated shaft 515. FIG. 5 shows that the dusting pad 100 may be coupled to the bottom portion of the attachment head 505, and the elongated shaft 515 may couple to the top portion of the attachment head 505. The dusting pad 100 may be coupled via fasteners such as hook and loop fasteners, and the elongated shaft 515 may be coupled to the top portion of the attachment head 505 via a joint 530 such as hinges, pivot, swivels, and the like. In one embodiment, the elongated shaft 515 may comprise a handle 525 attached to the distal end of the elongated shaft 515.

In one embodiment, the elongated shaft 515 may be a telescoping shaft, which allows the length of the cleaning apparatus 500 to be adjustable. Specifically, the elongated shaft 515 may comprise one or more sections that slide over one another. The elongated shaft 515 may be adjusted by various tightening mechanisms to secure a section with respect to another section.

The attachment head 505 may be a rigid plate adapted couple or fasten the dusting pad 100. The attachment head 505 may be rectangular in shape, as shown in FIG. 5, but may also be constructed in various shapes. As discussed above, the attachment head 505 may also comprise a hinge or pivot 530 for angular movement of the elongated shaft 515 and fasteners (e.g., hook and loop fastening material) for attachment of the dusting pad 100 to the attachment head 505.

During one embodiment of the operation, the user may couple or join the dusting pad 510 to the attachment head 505 via hook and loop fasteners and hook and loop fastening material 405. While the dusting pad 510 is resting on the ground surface, the user may grasp the handle 525 and adjust the elongated shaft 515 to a desired length. This may include adjusting the joint 530 of the cleaning apparatus 500 to a desired degree. Once the joint 530 is adjusted, the user may push the cleaning apparatus 500 across a floor or other surface to be cleaned.

A knitting machine may be used to knit the first material 105, and/or second material 110 onto the base layer 120. In one embodiment, the knitting machine may be a circular knitting machine with a diameter of 30 inches. In one embodiment, the knitting machine may be a Karl Mayer knitting machine, and in a preferred embodiment, the knitting machine may be a Karl Mayer, KS-4 FBX, warp-knitting machine.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A dusting pad comprising:
a base layer;
a first material; and
a second material;
wherein said base layer is constructed of a first synthetic material;
wherein said first material comprises a first plurality of threads in stitched relation with a bottom face of said base layer;
wherein said first plurality of threads project outwardly from said bottom face of said base layer;
wherein said second material comprises a second plurality of threads in stitched relation with said bottom face of said base layer; and
wherein said first plurality of threads have a greater average pile height than said second plurality of threads.

2. The dusting pad of claim 1, wherein said first plurality of threads comprises a plurality of fully drawn yarns.

3. The dusting pad of claim 2, wherein said plurality of fully drawn yarns of said first material are 150d/96f fully drawn yarns.

4. The dusting pad of claim 3, wherein a manufacturing of said plurality of fully drawn yarns of said first material include a steaming process.

5. The dusting pad of claim 4, wherein said steaming process of said plurality of fully drawn yarns of said first material is performed with dry saturated steam and at a temperature in a range between approximately 120 and 160 degrees Celsius for approximately 8 hours.

6. The dusting pad of claim 1, wherein said second plurality of threads is a second synthetic material.

7. The dusting pad of claim 6, wherein said second synthetic material is polyester.

8. The dusting pad of claim 1, wherein said second plurality of threads comprises a plurality of cationic draw textured yarns.

9. The dusting pad of claim 8, wherein said plurality of cationic draw textured yarns are 3 ply 150d/288f polyester yarns.

10. The dusting pad of claim 1, wherein said first synthetic material of said base layer is a 100d/36f drawn textured polyester yarn.

11. The dusting pad of claim 1, wherein a pile height of said first material is in the range between approximately 18 mm to 20 mm; and
wherein a pile height of said second material is in the range between approximately 8 mm to 10 mm.

12. The dusting pad of claim 1, wherein a weight per unit area of said dusting pad is in the range between approximately 500 to 540 grams per square meter.

13. The dusting pad of claim 1, wherein a top face of said base layer comprises a hook and loop material.

14. The dusting pad of claim 14, wherein said dusting pad is adapted to be removeably attached to a cleaning apparatus.

15. A dusting pad comprising:
a base layer;
a first material; and
a second material;
wherein said base layer is constructed of a first synthetic material;
wherein said first material comprises a first plurality of threads in stitched relation with a bottom face of said base layer;
wherein said first plurality of threads project outwardly from said bottom face of said base layer;
wherein said second material comprises a second plurality of threads in stitched relation with said bottom face of said base layer;
wherein said first plurality of threads have a greater average pile height than said second plurality of threads;
wherein said first plurality of threads comprises a plurality of fully drawn yarns;
wherein said plurality of fully drawn yarns of said first material are 150d/96f fully drawn yarns;
wherein a manufacturing of said plurality of fully drawn yarns of said first material include a steaming process;
wherein said steaming process of said plurality of fully drawn yarns of said first material is performed with dry saturated steam and at a temperature in a range between approximately 120 and 160 degrees Celsius for approximately 8 hours;
wherein said second plurality of threads is a second synthetic material;
wherein said second plurality of threads comprise a plurality of cationic draw textured yarns;
wherein said plurality of cationic draw textured yarns are 3 ply 150d/288f polyester yarns;
wherein said first synthetic material of said base layer is a 100d/36f drawn textured polyester yarn;
wherein a pile height of said first material is in the range between approximately 18 mm to 20 mm; and
wherein a pile height of said second material is in the range between approximately 8 mm to 10 mm;
wherein a weight per unit area of said dusting pad is in the range between approximately 500 to 540 grams per square meter;
wherein said top face of said base layer comprises a hook and loop material; and
wherein said dusting pad is adapted to be removeably attached to a cleaning apparatus.
